(19) United States
(12) Patent Application Publication
(10) Pub. No.: US 2023/0239979 A1
(43) Pub. Date: Jul. 27, 2023

(54) LIGHTING APPARATUS

(71) Applicant: LEEDARSON LIGHTING CO.,LTD., Zhangzhou (CN)

(72) Inventors: Zulun Hong, Zhangzhou (CN); Qiqiang Lin, Zhangzhou (CN); Yongqiang Wu, Zhangzhou (CN); Zongyuan Liu, Zhangzhou (CN); Yankun Li, Zhangzhou (CN); Hemu Ye, Zhangzhou (CN)

(21) Appl. No.: 18/101,457

(22) Filed: Jan. 25, 2023

(30) Foreign Application Priority Data
Jan. 25, 2022 (CN) 202220207957.3

(51) Int. Cl. H05B 45/392; H05B 45/325; H05B 45/10; H05B 45/20; H05B 45/3577

(52) U.S. Cl. CPC H05B 45/392; H05B 45/325; H05B 45/10; H05B 45/20; H05B 45/3577

(57) ABSTRACT

A lighting apparatus includes a light source, a main controller, a AC-DC converter, a dimmer signal extractor, a dimmer interface circuit and an isolating transformer. The AC-DC converter converts an external AC power to a driving current of a DC power for supplying power to the light source according to a control signal received by the main controller. The dimmer signal extractor generates the control signal supplied to the main controller according to a transformed signal. The dimmer interface circuit is connected to a dimmer. The dimmer is disposed on a wall to be operated by a user to generate a dimmer voltage. The dimmer voltage is converted to a dimmer signal. The isolating transformer has a secondary terminal connecting to the dimmer interface circuit and a first terminal connecting to the dimmer signal extractor.

### FIELD

The present invention is related to a lighting apparatus, and more particularly related to a lighting apparatus with a flexible control design.

### BACKGROUND

The time when the darkness is being lighten up by the light, human have noticed the need of lighting up this planet. Light has become one of the necessities we live with through the day and the night. During the darkness after sunset, there is no natural light, and human have been finding ways to light up the darkness with artificial light. From a torch, candles to the light we have nowadays, the use of light have been changed through decades and the development of lighting continues on.

Early human found the control of fire which is a turning point of the human history. Fire provides light to bright up the darkness that have allowed human activities to continue into the darker and colder hour of the hour after sunset. Fire gives human beings the first form of light and heat to cook food, make tools, have heat to live through cold winter and lighting to see in the dark.

Lighting is now not to be limited just for providing the light we need, but it is also for setting up the mood and atmosphere being created for an area. Proper lighting for an area needs a good combination of daylight conditions and artificial lights. There are many ways to improve lighting in a better cost and energy saving. LED lighting, a solid-state lamp that uses light-emitting diodes as the source of light, is a solution when it comes to energy-efficient lighting. LED lighting provides lower cost, energy saving and longer life span.

The major use of the light emitting diodes is for illumination. The light emitting diodes is recently used in light bulb, light strip or light tube for a longer lifetime and a lower energy consumption of the light. The light emitting diodes shows a new type of illumination which brings more convenience to our lives. Nowadays, light emitting diode light may be often seen in the market with various forms and affordable prices.

After the invention of LEDs, the neon indicator and incandescent lamps are gradually replaced. However, the cost of initial commercial LEDs was extremely high, making them rare to be applied for practical use. Also, LEDs only illuminated red light at early stage. The brightness of the light only could be used as indicator for it was too dark to illuminate an area. Unlike modern LEDs which are bound in transparent plastic cases, LEDs in early stage were packed in metal cases.

In 1878, Thomas Edison tried to make a usable light bulb after experimenting different materials. In November 1879, Edison filed a patent for an electric lamp with a carbon filament and keep testing to find the perfect filament for his light bulb. The highest melting point of any chemical element, tungsten, was known by Edison to be an excellent material for light bulb filaments, but the machinery needed to produce super-fine tungsten wire was not available in the late 19th century. Tungsten is still the primary material used in incandescent bulb filaments today.

Early candles were made in China in about 200 BC from whale fat and rice paper wick. They were made from other materials through time, like tallow, spermaceti, colza oil and beeswax until the discovery of paraffin wax which made production of candles cheap and affordable to everyone. Wick was also improved over time that made from paper, cotton, hemp and flax with different times and ways of burning. Although not a major light source now, candles are still here as decorative items and a light source in emergency situations. They are used for celebrations such as birthdays, religious rituals, for making atmosphere and as a decor.

Illumination has been improved throughout the times. Even now, the lighting device we used today are still being improved. From the illumination of the sun to the time when human can control fire for providing illumination which changed human history, we have been improving the lighting source for a better efficiency and sense. From the invention of candle, gas lamp, electric carbon arc lamp, kerosene lamp, light bulb, fluorescent lamp to LED lamp, the improvement of illumination shows the necessity of light in human lives.

There are various types of lighting apparatuses. When cost and light efficiency of LED have shown great effect compared with traditional lighting devices, people look for even better light output. It is important to recognize factors that can bring more satisfaction and light quality and flexibility.

There are various ways to control a light device. For example, 0-10V dimmer is widely used in today light devices to adjust light intensity levels of the light device.

However, when the light device adopts LED modules as its light source, the converter of the 0-10V dimmer is complicated. To make the LED light devices more convenient, it is helpful if a better converter circuit can be designed.

### SUMMARY

In some embodiments, a lighting apparatus includes a light source, a main controller, a AC-DC converter, a dimmer signal extractor, a dimmer interface circuit and an isolating transformer.

The AC-DC converter converts an external AC power to a driving current of a DC power for supplying power to the light source according to a control signal received by the main controller.

The dimmer signal extractor generates the control signal supplied to the main controller according to a transformed signal.

The dimmer interface circuit is connected to a dimmer.

The dimmer is disposed on a wall to be operated by a user to generate a dimmer voltage.

The dimmer voltage is converted to a dimmer signal.

The isolating transformer has a secondary terminal connecting to the dimmer interface circuit and a first terminal connecting to the dimmer signal extractor.

The isolating transformer generates the transformed signal from the dimmer signal via coils on a common metal unit.

In some embodiments, a transformer switch module is connected between the isolating transformer and the dimmer signal extractor.

In some embodiments, a direct current switch module is connected to the isolating transformer.

The direct current switch module and the transformer switch module are coupled to the first terminals of the isolating transformer.

In some embodiments, the direct current switch module includes a first transistor.

The first transistor has a gate terminal connected to a ground via a first Zener diode.

A first capacitor is connected to the ground and to the gate terminal of the first transistor via a first resistor.

In some embodiments, the dimmer signal extractor includes a sampling filter circuit and a detection circuit.

The sampling filter circuit filters the transformed signal to a filtered signal.

The detector circuit includes two resistors for moving the filtered signal to a corresponding voltage level as the control signal.

In some embodiments, the dimmer interface circuit couples to the dimmer for receiving the dimmer voltage corresponding to the operation of the user to indicate a desired value in a predetermined range.

In some embodiments, the dimmer voltage is between 0V and 10V.

In some embodiments, the dimmer voltage is between 1V and 10V.

In some embodiments, the control signal is converted to at least one PWM signal by the main controller to adjust the driving current supplied to the light source.

In some embodiments, the light source includes multiple LED modules with different color temperatures.

The main controller changes the control signal to change both a light intensity and a mixed color temperature of the multiple LED modules when the dimmer voltage is changed.

In some embodiments, the dimmer voltage is used by the main controller to change a mixed color temperature of the light source.

In some embodiments, the lighting apparatus may also include a mode switch for indicating whether the dimmer voltage is used to adjust the mixed color temperature.

In some embodiments, the main controller detects a variation pattern of the control signal to change an operation mode to interpret the dimmer voltage.

In some embodiments, the dimmer voltage is converted to different control parameters for controlling the light source under different operation modes.

In some embodiments, the lighting apparatus may also include a manual switch for enabling or disabling the isolating transformer.

In some embodiments, the main controller has a wireless interface for transmitting a value of the control signal to an external device.

In some embodiments, the external device adjusts a wireless command sent to the main controller according to the value of the control signal.

In some embodiments, the main controller generates a remote control signal to a remote light device according to the control signal so that the dimmer controls the remote light device via the lighting apparatus.

In some embodiments, the main controller keeps an intensity table for storing light intensity levels associated with different dimmer voltages.

In some embodiments, the main controller keeps multiple light intensity tables and selects one from the multiple light intensity tables to convert the dimmer voltage to a corresponding light intensity of the light source.

### BRIEF DESCRIPTION OF DRAWINGS

FIG. 1 illustrates a lighting apparatus embodiment.

FIG. 2 illustrates a lighting apparatus embodiment with a dimmer converter.

FIG. 3 illustrates another lighting apparatus with a dimmer converter.

FIG. 4 illustrates a detailed example of a dimmer converter circuit.

FIG. 5 illustrates an architecture diagram of a lighting apparatus.

FIG. 6 illustrates another architecture diagram of a lighting apparatus.

FIG. 7 illustrates a circuit example of a lighting apparatus embodiment.

FIG. 8 illustrates a lighting apparatus example showing a dimmer control.

FIG. 9 shows an example of an isolating transformer.

FIG. 10 shows signal processing example of a dimmer signal extractor.

FIG. 11 shows light intensity table examples.

### DETAILED DESCRIPTION

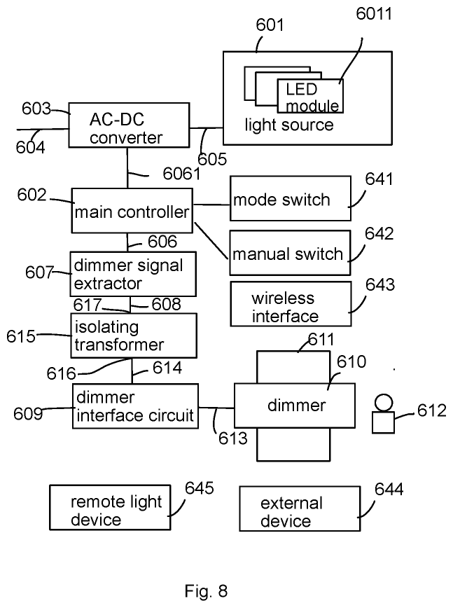

In FIG. 8, a lighting apparatus includes a light source 601, a main controller 602, a AC-DC converter 603, a dimmer signal extractor 607, a dimmer interface circuit 609 and an isolating transformer 615.

The AC-DC converter 603 converts an external AC power 604 to a driving current 605 of a DC power for supplying power to the light source 601 according to a control signal 606 received by the main controller 602.

The dimmer signal extractor 609 generates the control signal 606 supplied to the main controller 602 according to a transformed signal 608.

The dimmer interface circuit 609 is connected to a dimmer 610.

The dimmer 610 is disposed on a wall 611 to be operated by a user 612 to generate a dimmer voltage 613.

For example, the dimmer 610 may include a rotation button or an adjusting bar for setting a value by changing a relative position or a relative angle by the user 612.

The dimmer voltage 613 is converted to a dimmer signal 614.

The isolating transformer 614 has a secondary terminal 616 connecting to the dimmer interface circuit 609 and a first terminal 617 connecting to the dimmer signal extractor 607.

The isolating transformer 615 generates the transformed signal 608 from the dimmer signal 614 via coils on a common metal unit.

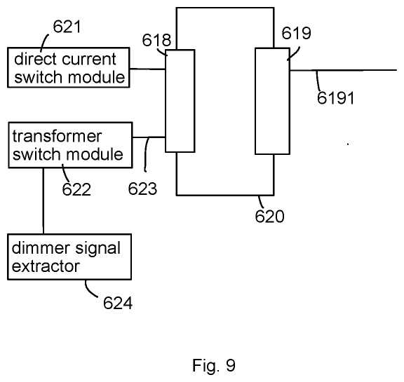

FIG. 9 shows two coils 618, 619 mounted on the same metal unit 620, which is a common transformer design using electro-magnetic theory. A signal on one coil 619 may be transformed to another signal on another coil 618.

In FIG. 9, a transformer switch module 622 is connected between the isolating transformer and the dimmer signal extractor 624.

In FIG. 9, a direct current switch module 621 is connected to the isolating transformer.

The direct current switch module 621 and the transformer switch module 622 are coupled to the first terminals of the isolating transformer.

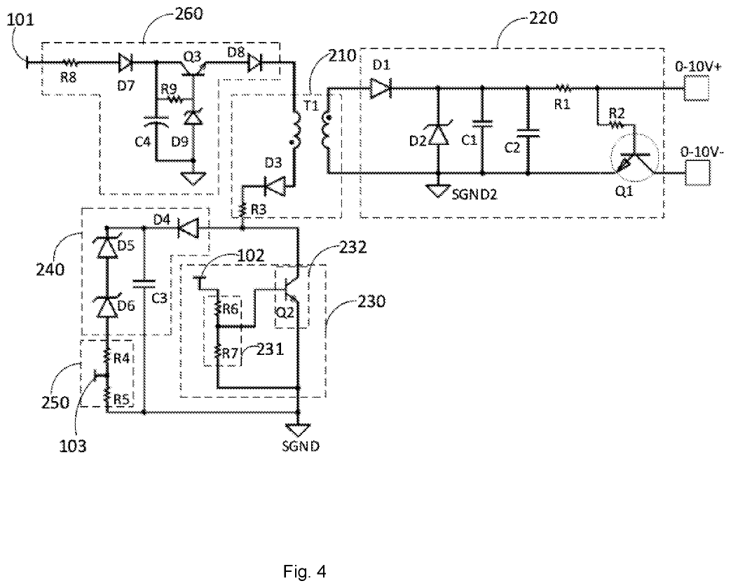

In FIG. 4, the direct current switch module 260 includes a first transistor Q3.

In the example of FIG. 4, the first transistor Q3 has a gate terminal connected to a ground via a first Zener diode D9.

A first capacitor C4 is connected to the ground and to the gate terminal of the first transistor Q3 via a first resistor R9.

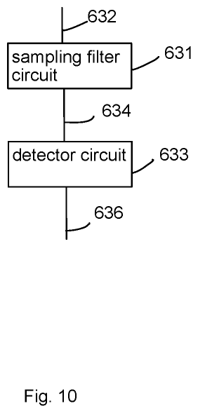

In FIG. 10, the dimmer signal extractor includes a sampling filter circuit 631 and a detection circuit 633.

The sampling filter circuit 631 filters the transformed signal 632 to a filtered signal 634.

The detector circuit 633 includes two resistors for moving the filtered signal 634 to a corresponding voltage level 636 as the control signal.

In FIG. 4, the sampling filter circuit 240 filters the transformed signal obtained from the isolating transformer 210. The filtered signal is then detected with two resistors R4, R5 to adjust to a desired voltage level 103.

The sampling filter circuit 240 has two Zenor diodes D5, D6, a capacitor C3 and a diode D4. The isolating transformer 210 has coils and a diode D3 and a resistor R3.

The direct current switch module 260 receives a direct current source 101 and has a resistor R8, a diode D7, a transistor Q3, a diode D8 connected in series.

In FIG. 4, the dimmer interface circuit 220 couples to the dimmer for receiving the dimmer voltage corresponding to the operation of the user to indicate a desired value in a predetermined range.

The dimmer interface circuit 220 in FIG. 4 includes a diode D1, a Zenor diode D2, two capacitors C1, C2, two resistors R1, R2 and a transistor 0V couple to 0-10V+ and 0-10V− terminals.

In some embodiments, the dimmer voltage is between 0V and 10V. In such case, the dimmer voltage may be selected by a user to be set between 0V and 10V for tuning a rotation button or a bar.

In some embodiments, the dimmer voltage is between 1V and 10V. In such case, the dimmer voltage may be selected by a user to be set between 1V and 10V for tuning a rotation button or a bar.

In FIG. 8, the control signal 606 is converted to at least one PWM signal 6061 by the main controller 606 to adjust the driving current 605 supplied to the light source 601.

PWM refers to Pulse Width Modulation, which uses a duty ratio turning-on time periods to adjust a current value or other parameters.

In some embodiments, the light source 601 includes multiple LED modules 6011 with different color temperatures. By controlling a relative ration among driving currents supplied to the LED modules 6011, a different mixed color temperature may be obtained.

In other words, the control signal 606 may be converted to corresponding one or multiple PWM signals for adjusting driving currents supplied to different LED modules to obtain a desired light parameter like color temperature.

In some embodiments, the main controller changes the control signal to change both a light intensity and a mixed color temperature of the multiple LED modules when the dimmer voltage is changed.

For example, the main controller controls the multiple LED modules to emit mixed lights by reducing the color temperature (CCT) of the light when it is dimmed, from 2800K at 100% light intensity to 2000 K as the light intensity approaches 0%.

In some embodiments, the dimmer voltage is used by the main controller to change a mixed color temperature of the light source.

In FIG. 8, the lighting apparatus may also include a mode switch 641 for indicating whether the dimmer voltage is used to adjust the mixed color temperature.

In some embodiments, the main controller detects a variation pattern of the control signal to change an operation mode to interpret the dimmer voltage.

For example, when the user turns the 0-10V dimmer from zero to 100% for three times within 3 seconds, the main controller interprets such operation as a mode switch operation. In such case, the main controller changes its working mode accordingly, e.g. determine how to interpret the 0-10V dimmer adjustment.

In some embodiments, the dimmer voltage is converted to different control parameters for controlling the light source under different operation modes.

In FIG. 8, the lighting apparatus may also include a manual switch 642 for enabling or disabling the isolating transformer. In such case, the lighting apparatus may have multiple sets of circuit paths. The circuit path of the isolating transformer may be disabled or enanbled depending on users requirements.

In FIG. 8, the main controller has a wireless interface 643 for transmitting a value of the control signal to an external device 644.

In some embodiments, the external device 644 adjusts a wireless command sent to the main controller 602 according to the value of the control signal.

In FIG. 8, the main controller generates a remote control signal to a remote light device 645 according to the control signal so that the dimmer controls the remote light device 645 via the lighting apparatus. In other words, when the user operates a dimmer, two light devices are controlled at the same time, even the remote light device is not directly connected to the operated dimmer.

In some embodiments, the main controller keeps an intensity table for storing light intensity levels associated with different dimmer voltages.

In some embodiments, the main controller keeps multiple light intensity tables and selects one from the multiple light intensity tables to convert the dimmer voltage to a corresponding light intensity of the light source.

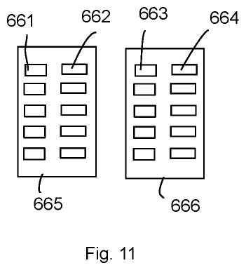

FIG. 11 shows two light intensity tables 665, 666. The two light intensity tables records different mapping relations between 0-10V dimmer voltages 661, 663 to light intensities 662, 664.

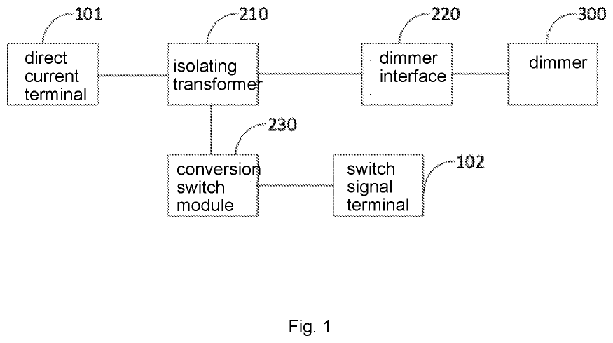

FIG. 1 shows a lighting apparatus embodiment.

In FIG. 1, the lighting apparatus includes a direct current terminal 101 for receiving a direct current. The isolating transformer 210 is disposed between the dimmer interface 220 and the conversion switch module 230. The dimmer interface 220 is connected to a dimmer 300.

The switch signal terminal 102 is connected to the conversion switch 230.

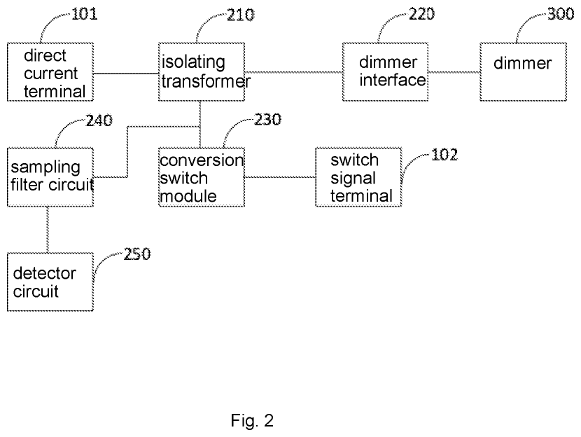

FIG. 2 shows another lighting apparatus embodiment. The same reference numerals refer to the same components. There are some elements not disclosed in FIG. 1.

In FIG. 2, the isolating transformer 210 converts a dimmer signal from the dimmer interface 220. The dimmer interface 220 converts the dimmer voltage to the dimmer signal. The dimmer signal is further converted to a transformed signal that is processed by the sampling filter circuit 240 and the detector circuit 250 as mentioned above.

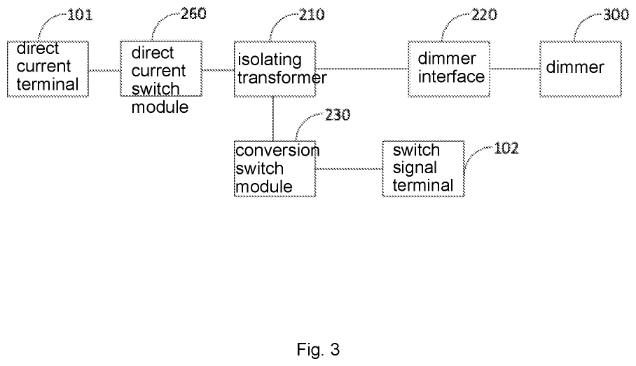

FIG. 3 shows another embodiment similar to the examples in FIG. 1 and FIG. 3 with some different element arrangement.

In FIG. 3, there is a direct current switch module 260 for converting the direct current received from the direct current terminal 101.

FIG. 4 shows a detailed circuit example for the examples in FIG. 1, FIG. 2 and FIG. 3.

In FIG. 4, the same reference numerals refer to the same components or examples in FIG. 1, FIG. 2, and FIG. 3.

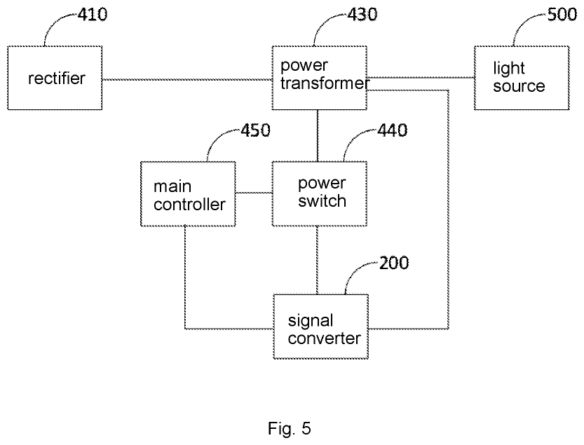

FIG. 5 shows a lighting apparatus example.

In FIG. 5, the rectifier 410 may includes a transformer bridge to convert an AC power to a DC power. The power transformer 430 further filters and processes the power to generate corresponding driving currents to the light source 500. There are a power switch 440 that is controlled by a main controller 450. The dimmer voltage may be processed by a signal converter 200 as mentioned above to be embedded and transmitted to the main controller 450.

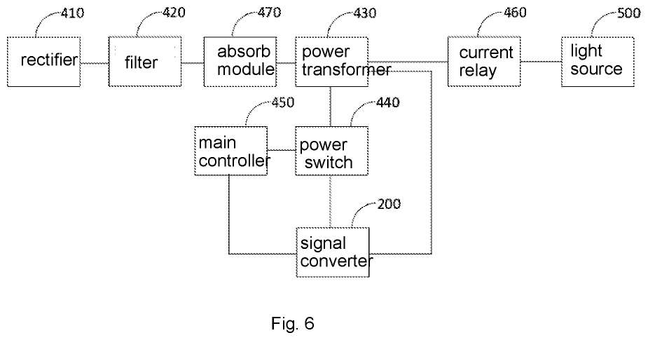

FIG. 6 shows another lighting apparatus embodiment similar to the example in FIG. 5. In FIG. 6, in addition to the elements illustrated in FIG. 5, there are a filter 420 for filtering the power, an absorb module to remove unwanted noise, and a current relay disposed between the light source 500 and the power transformer 430.

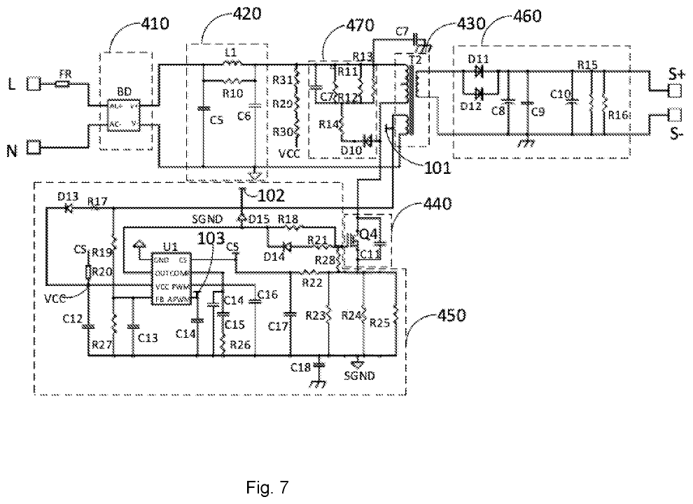

FIG. 7 shows a detailed circuit example illustrating an example to implement each block shown in FIG. 5 and FIG. 6. The same reference numerals refer to the same components or examples in FIG. 5 and FIG. 6.

In FIG. 7, the rectifier 410 has a bridge circuit. The filter 420 includes a PI filter. The absorb circuit 470 includes a capacitor, multiple resistors and a diode to remove unwanted signals.

The power transformer 430 includes a transformer that includes coils and metals. The direct current terminals 101, 102 may refer to the examples in FIG. 1 to FIG. 4.

The current relay 460 includes diodes, capacitors and resistors for supplying power to the light source.

The power switch 440 has a transistor Q4 for converting power. The main controller includes a control chip U1 to handle PWM signals and the transformed signal to control the light source.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus, comprising:
a light source;
a main controller;
a AC-DC converter for converting an external AC power to a driving current of a DC power for supplying power to the light source according to a control signal received by the main controller;
a dimmer signal extractor for generating the control signal supplied to the main controller according to a transformed signal;
a dimmer interface circuit connecting to a dimmer, wherein the dimmer is disposed on a wall to be operated by a user to generate a dimmer voltage, wherein the dimmer voltage is converted to a dimmer signal; and
an isolating transformer with a secondary terminal connecting to the dimmer interface circuit and a first terminal connecting to the dimmer signal extractor, wherein the isolating transformer generates the transformed signal from the dimmer signal via coils on a common metal unit.

2. The lighting apparatus of claim 1, wherein a transformer switch module is connected between the isolating transformer and the dimmer signal extractor.

3. The lighting apparatus of claim 2, wherein a direct current switch module is connected to the isolating transformer, wherein the direct current switch module and the transformer switch module are coupled to the first terminals of the isolating transformer.

4. The lighting apparatus of claim 3, wherein the direct current switch module comprises a first transistor, wherein the first transistor has a gate terminal connected to a ground via a first Zener diode, wherein a first capacitor is connected to the ground and to the gate terminal of the first transistor via a first resistor.

5. The lighting apparatus of claim 1, wherein the dimmer signal extractor comprises a sampling filter circuit and a detection circuit, wherein the sampling filter circuit filters the transformed signal to a filtered signal, wherein the detector circuit comprises two resistors for moving the filtered signal to a corresponding voltage level as the control signal.

6. The lighting apparatus of claim 1, wherein the dimmer interface circuit couples to the dimmer for receiving the dimmer voltage corresponding to the operation of the user to indicate a desired value in a predetermined range.

7. The lighting apparatus of claim 6, wherein the dimmer voltage is between 0V and 10V.

8. The lighting apparatus of claim 6, wherein the dimmer voltage is between 1V and 10V.

9. The lighting apparatus of claim 1, wherein the control signal is converted to at least one PWM signal by the main controller to adjust the driving current supplied to the light source.

10. The lighting apparatus of claim 1, wherein the light source comprises multiple LED modules with different color temperatures, wherein the main controller changes the control signal to change both a light intensity and a mixed color temperature of the multiple LED modules when the dimmer voltage is changed.

11. The lighting apparatus of claim 1, wherein the dimmer voltage is used by the main controller to change a mixed color temperature of the light source.

12. The lighting apparatus of claim 11, further comprising a mode switch for indicating whether the dimmer voltage is used to adjust the mixed color temperature.

13. The lighting apparatus of claim 1, wherein the main controller detects a variation pattern of the control signal to change an operation mode to interpret the dimmer voltage.

14. The lighting apparatus of claim 13, wherein the dimmer voltage is converted to different control parameters for controlling the light source under different operation modes.

15. The lighting apparatus of claim 1, further comprising a manual switch for enabling or disabling the isolating transformer.

16. The lighting apparatus of claim 1, wherein the main controller has a wireless interface for transmitting a value of the control signal to an external device.

17. The lighting apparatus of claim 16, wherein the external device adjusts a wireless command sent to the main controller according to the value of the control signal.

18. The lighting apparatus of claim 1, wherein the main controller generates a remote control signal to a remote light device according to the control signal so that the dimmer controls the remote light device via the lighting apparatus.

19. The lighting apparatus of claim 1, wherein the main controller keeps an intensity table for storing light intensity levels associated with different dimmer voltages.

20. The lighting apparatus of claim 19, wherein the main controller keeps multiple light intensity tables and selects one from the multiple light intensity tables to convert the dimmer voltage to a corresponding light intensity of the light source.
